(19) United States
(12) Patent Application Publication
(10) Pub. No.: US 2005/0232263 A1
(43) Pub. Date: Oct. 20, 2005

(54) Communication control apparatus, communication network and method of updating packet transfer control information

(76) Inventor: Kazuhiko Sagara, Tokyo (JP)

Correspondence Address: REED SMITH LLP, Suite 1400, 3110 Fairview Park Drive, Falls Church, VA, 22042, US

(21) Appl. No.: 10/929,797

(22) Filed: Aug. 31, 2004

(30) Foreign Application Priority Data
Feb. 25, 2004 (JP) 2004-049121

(51) Int. Cl. H04L 12/56

(52) U.S. Cl. 370/389

(57) ABSTRACT

A control node apparatus is installed in a packet communication network. The control node apparatus has a function for updating packet transfer control information and for broadcasting the updated information to other node apparatus in the packet communication network, in response to a control packet transmitted from a user terminal prior to data communication.

### CLAIM OF PRIORITY

The present application claims priority from Japanese application serial no. 2004-049121, filed on Feb. 25, 2004, the content of which is hereby incorporated by reference into this application.

### BACKGROUND OF THE INVENTION

1. Field of the Invention

The present invention relates to a packet communication system, and more particularly to a communication control apparatus, a communication network and a method of updating packet transfer control information, capable of realizing packet transfer with communication quality according to a user request.

2. Description of the Related Art

With the advent of broadband services or high-security data communication services, it is necessary to realize packet transfer with assured communication quality on networks. MPLS (Multi-Protocol Label Switching), VPN (Virtual Private Network), etc. are well-known assurance techniques in communication quality on networks.

In the MPLS or VPN, a node apparatus installed at the entrance of a network adds label information to an incoming packet. Further, each node apparatus in the network routes the received packet by force in accordance with the label information, thereby providing guaranteed communication quality. Thus, the important matter for the network manager is to follow the rule of adding the label information to each packet, that is, how to manage and maintain a communication control information data base included in each node apparatus.

Conventionally, to set this kind of data base information in a communication node apparatus at the time of network provisioning, the communication carrier connects a management terminal to each communication node apparatus, and inputs control information to be registered in a data base from this terminal.

In recent years, for example, as shown in Unexamined Japanese Patent Publication No. 2000-253053 (EP 1 156 629A1: patent document 1) and No. 2000-312226 (patent document 2), a centralized management system is proposed as a new mechanism for network management. According to the patent documents, a new management network is configured over a plurality of networks, and control information of each communication node apparatus is centrally managed through the management network. There is also proposed another technique for rewriting the data base of the communication node apparatus through the utilization of a WEB server or policy server.

With the advance in the function of the user terminal connected to the network and with an increase in the number of terminals, there are a wide variety of user requests for communication quality more and more. To satisfy such user needs, it is necessary to dynamically set the control information for each node apparatus in order to achieve assured communication quality. Particularly, many personal users wish to specify a desired communication form or necessary communication quality in the user terminal every time data communication is executed and to set the packet transfer control information in real time so as to begin data communication immediately with a destination apparatus, without negotiating with the network manager. In addition, if the user terminal often connects and disconnects to and from the network, the traffic on the network remarkably changes. Thus, it is also necessary to dynamically set the packet transfer control information in consideration of the traffic state.

FIG. 24 illustrates a network configuration of a centralized management type which comprises access networks 1A and 1B, a core communication network 100 and a management network 8 having a management terminal 80. The access networks 1A and 1B respectively include a plurality of terminals 10A (10A-1 to 1OA-n) and a plurality of terminals 10B (10B-i to 10B-m). The core access network 100 is connected to the access networks 1A and 1B. In the configuration, the management terminal 80 sets packet transfer control information through a communication line, for a plurality of routers 2 (2-1, 2-2, . . . ) installed in the communication network 100 as node apparatuses. In the network of the centralized management type, a terminal user who wishes to secure the communication quality makes a contract for bandwidth assurance with the network manager through a document or an e-mail, etc. Then, the network manager updates a data base of the management terminal 80 based on this contract, and the updated contents are reflected in a packet transfer control information data base installed in each router 2 in the communication network 100.

However, in the network of the above-described centralized management type, terminal users need to individually make the contract with the network manager. This results in a problem that it takes quite a long time to set and update the packet transfer control information or a packet transfer rule in each node apparatus. For the terminal users to occasionally make the contract, prior to data communication, each user terminal and the management terminal 80 needs to perform data communication in real time. However, in the present circumstances, an address of the management terminal 80 is not public to general users. Therefore, in the network of the centralized management type, it is in fact difficult to secure the communication quality in accordance with an individual communication form in real time and to dynamically establish a communication path in association with the user needs.

### SUMMARY OF THE INVENTION

It is accordingly an object of the present invention to provided a communication control apparatus, a communication network, and a method of updating packet transfer, capable of occasionally providing assurance on communication quality in accordance with an individual communication form without user's negotiation with a network manager beforehand.

Another object of the present invention is to provide a communication control apparatus, a communication network and a method of updating packet transfer control information, capable of dynamically controlling packet transfer in a communication network in conformity with a user-specified communication form or communication quality.

In order to attain the above objects, according to the present invention, there is provided in a packet communication network, a control node apparatus having a function for updating packet transfer control information and broadcasting (advertising) the updated information to other node apparatuses in the packet communication network, in response to a control packet transmitted from a user terminal prior to data communication. Such a function of the control node apparatus may be installed to an ordinary node apparatus having a routing function for a received packet. The ordinary node apparatus may be, for example, an optical cross-connect node operating in layer 1 of the OSI reference model, a LAN switch operating in layer 2 of the reference model, an IP router or label switching router (LSR) operating in layer 3 of the reference model, etc.

In more particular, the control node apparatus according to the present invention comprises: a data base for storing packet transfer control information; a received packet analyzing means for terminating a control packet when the control packet is received, the control packet including communication control information specified by a terminal user in its payload part; means for updating the data base based on the communication control information specified in the control packet; and data base information communication means for autonomously informing the plurality of node apparatuses in the communication network about contents of the updated data base.

The data base information communication means communicates data base information in accordance with a predetermined communication protocol common to the data bases at the plurality of node apparatuses in the communication network. The received packet analyzing means determines whether a received packet is a control packet or not, based on status of a particular header information element included in a header of the received packet.

According to the present invention, there is provided a method of updating packet transfer control information in a packet communication network comprising a plurality of node apparatuses each having a data base for storing the packet transfer control information, the method comprising the steps of: updating when one of the node apparatuses in the communication network receives a control packet including the communication control information specified by a terminal user in its payload part, the data base associated with the node apparatus based on the communication control information specified in the received control packet; and executing communication among the node apparatus which has updated the data base and the other node apparatuses in the communication network, in order to synchronize the packet transfer control information in the data bases of the plurality of node apparatuses.

In the preferred embodiments of the present invention, the communication network is logically comprises a data plane for transferring user packets transmitted from user terminals among a plurality of node apparatuses and a control plane for communicating packet transfer control information among a plurality of data bases, and one of the node apparatuses transfers a user packet to another one of the node apparatuses in the data plane upon receiving the user packet, and executes communication for synchronizing the packet transfer control information stored in the data base with the other data bases in the control plane upon updating the data base in response to the reception of the control packet.

According to the present invention, there is provided a communication network comprising a plurality of node apparatuses and plurality of access networks connected to user terminals, wherein: each of the plurality of node apparatuses has a data base for storing packet transfer control information; one of the node apparatuses has a data base information control means for updating the data base when the node apparatus receives a control packet including, the communication control information specified by a terminal user in its payload part, based on the communication control information specified in the received control packet; and each of the plurality of node apparatuses has means for communicating data base information using a predetermined protocol in order to synchronize contents of the respective data bases.

LSA (Link State Advertisement) protocol or LMP (Link Management Protocol) of an OSPF-TE (Open Shortest Path First-Traffic Engineering-Task Force) may be used as a communication protocol for data base synchronization. The data base synchronization using such a communication protocol is occasionally executed, upon updating the contents of the data base in response to the control packet transmitted from a user terminal. Other objects, features, and operational modes of the present invention will become more apparent upon reading of the following detailed description with reference to the drawings.

### BRIEF DESCRIPTION OF THE DRAWINGS

FIG. 1A is a diagram showing a network system of a first embodiment to which a control apparatus of the present invention is applied.

FIG. 1B is a logical block diagram corresponding to the network system shown in FIG. 1A.

FIG. 2A is a diagram showing a network system of a second embodiment to which a control apparatus of the present invention is applied.

FIG. 2B is a logical block diagram corresponding to the network system shown in FIG. 2A.

FIG. 3A is a diagram showing a network system of a third embodiment to which a control apparatus of the present invention is applied.

FIG. 3B is a logical block diagram corresponding to the network system shown in FIG. 2A.

FIG. 4A is a diagram showing a network system of a fourth embodiment in which the principle of the present invention is applied to a user terminal.

FIG. 4B is a logical block diagram corresponding to the network system shown in FIG. 4A.

FIG. 5 is a diagram showing a packet format of IPv4 version applied to a control packet used for the control apparatus of the present invention.

FIG. 6 is a diagram showing a packet format of IPv6 version applied to the control packet used for the control apparatus of the present invention.

FIG. 7 is a diagram exemplifying an initial screen of a service editor displayed on a user terminal.

FIG. 8 is a diagram exemplifying a service selection window, displayed on the user terminal.

FIG. 9 is a diagram showing a menu window for an e-mail service, displayed on the user terminal.

FIG. 10 is a diagram showing a menu window for an electronic commerce service, displayed on the user terminal.

FIG. 11 is a diagram showing a menu window for a file backup service, displayed on the user terminal.

FIG. 12 is a diagram showing a menu window for a time-specified delivery service, displayed on the user terminal.

FIGS. 13A, 13B, 13C and 13D are diagrams each showing a control packet which is generated in association with the menu windows shown in FIGS. 9 to 12, respectively.

FIG. 14 is a block diagram showing an embodiment of a control apparatus 40 according to the present invention.

FIG. 15 is a block diagram showing an embodiment of a control apparatus 50 according to the present invention.

FIG. 16 is a block diagram showing an embodiment of an interface module 510 shown in FIG. 15.

FIG. 17A is a diagram showing a network including label switch routers which are applications of the control apparatus according to the present invention.

FIG. 17B is a logical block diagram corresponding to the network system shown in FIG. 17A.

FIG. 18 is a diagram exemplifying a label conversion table formed by the control apparatus shown in FIG. 17A.

FIG. 19A is a diagram showing a network including LAN switches which are applications of the control apparatus according to the present invention.

FIG. 19B is a logical block diagram corresponding to the network system shown in FIG. 19A.

FIG. 20 is a diagram exemplifying the main part of the label conversion table formed by the control apparatus in FIG. 19.

FIG. 21A is a diagram showing a network including optical cross-connect nodes which are applications of the control apparatus according to the present invention.

FIG. 21B is a logical block diagram corresponding to the network system shown in FIG. 21A.

FIG. 22 is a diagram exemplifying the main part of the label conversion table formed by the control apparatus in FIG. 21.

FIG. 23 is a block diagram showing another embodiment of a network system to which the control apparatus of the present invention is applied.

FIG. 24 is a block diagram exemplifying a conventional network system.

### DETAILED DESCRIPTION OF THE PREFERRED EMBODIMENTS

Embodiments of the present invention will now be described with reference to the accompanying drawings.

### First Embodiment

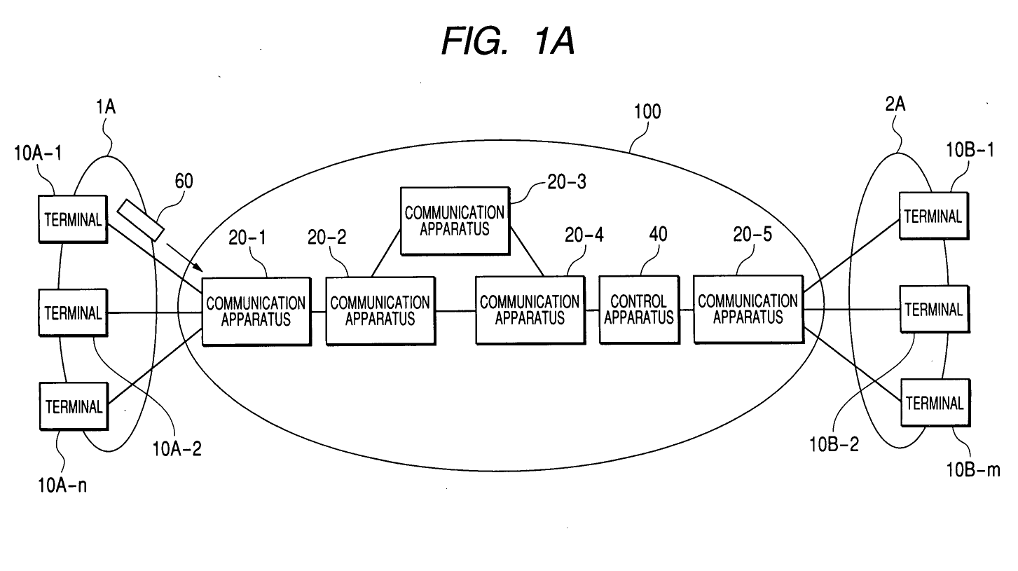

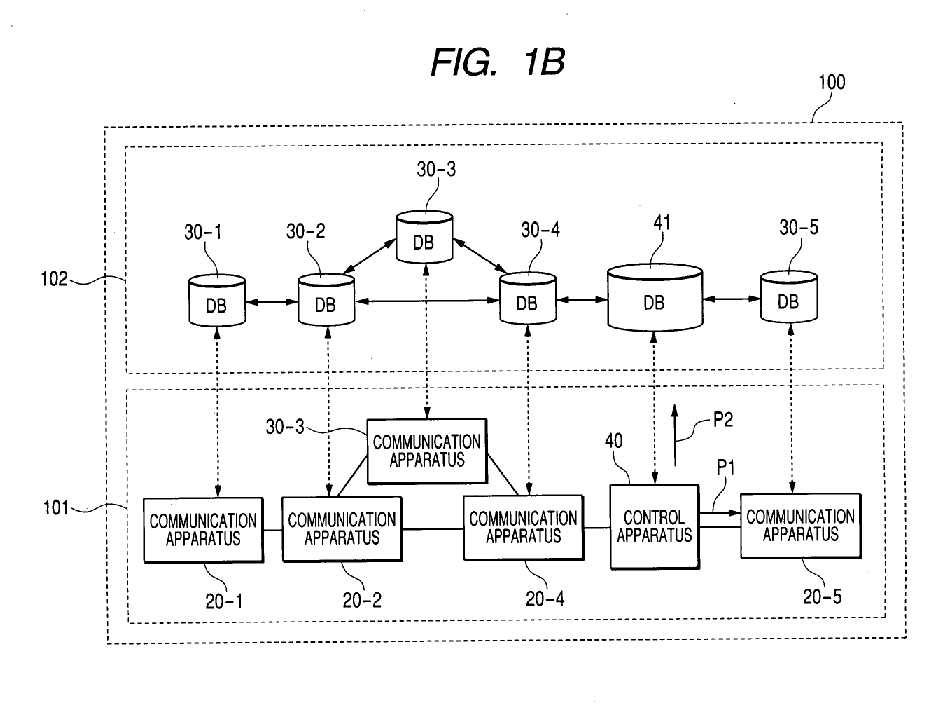

FIG. 1A shows a network configuration which comprises an access network 1A including a plurality of terminals 10A (10A-1 to 10A-n), an access network 1B including a plurality of terminals 10B (10B-1 to 10B-m), and a communication network (IP network) 100 connected to these access networks.

The communication network 100 includes, as node apparatuses, communication apparatuses 20 (20-1 to 20-5) and a control apparatus (control node apparatus) 40. The control apparatus 40 has an immediate setting function for setting packet transfer control information according to the present invention. Each of the communication apparatuses 20 includes, as illustrated in FIG. 1B, a data base 30 (30-1 to 30-5) for storing packet transfer control information. These data bases 30 perform cooperative operations together with a data base 41 associated with the control apparatus 40 using a protocol common to them, so as to synchronize stored information.

In the case of this embodiment, each of the communication apparatuses 20 (20- to 20-3) is comprised of a node apparatus, such as an MPLS (Multi-Protocol Label Switching) router, a VLAN (Virtual Local Area Network) switch, an OXC (Optical Cross Connect), etc. capable of processing an OSI (Open Systems Interconnection) protocol stack of the same kind to each other. Among these node apparatuses, by setting a path for the MPLS, VLAN or OXC in the communication network 100 in accordance with the stored information in the data base, reliable packet communication with guaranteed QoS (Quality of Service) can be realized.

In the present invention, each terminal 10A (1A-1 to 10B-m) in the access network 1 (1A, 1B) transmits a control packet including communication control information in its payload part to a destination communication apparatus, prior to packet communication between the terminal 1A and the destination apparatus. The above-described control packet is generated when the user of the terminal 10A selects a desired communication service on a terminal screen and inputs an operation command in accordance with a menu window thereon, as will be explained later.

For example, in the case where the terminal 10A-1 in the access network 1A communicates with the terminal 10B-1 in the access network 1B, routing of a control packet 60 sent by the terminal 10A-1 is executed within the communication network 100 based on an address specified in the packet header, and the packet 60 reaches the control apparatus 40.

The communication network 100 is, logically, separated into a data plane 101 and a control plane 102, as illustrated in FIG. 1B. The node apparatuses shown in FIG. 1A belong to the data plane 101, while the data bases 30 (30-1 to 30-5) of the respective communication node apparatuses and the control apparatus 40 belong to the data plane 102.

Topology information and link status information of the communication network 100 is stored in the data bases 41 and 30 (30-1 to 30-2) which belong to the control plane 102. Further, various label conversion tables are formed in the data bases in accordance with the kind of the communication apparatuses 20 (20-1 to 20-3) in the communication network 100. As the label conversion table, for example, a routing table, an MPLS forwarding table, a VPN management table or the like is formed in the case where the communication apparatuses 20 are MPLS routers. In the case where the apparatuses 20 are VLAN switches, for example, a VLAN table is formed as the label conversion table, whereas a wave length management table is formed in the case where the apparatuses 20 are OXCs.

The contents of such data bases are autonomously synchronized based on an extension version of a routing protocol, such as an Opaque LSA (Link State Advertisement) of OSPF-TE (Open Shortest Path First-Traffic Engineering) specified in draft-ietf-ccamp-ospf-gmpls-extension-11 of IETF (Internet Engineering Task Force), or an RIP (Routing Information Protocol) etc. When the data base of any of the communication node apparatuses is updated, the updated contents is reflected in other data bases of the communication network 100.

In this embodiment, the control apparatus 40 analyzes header information of a received packet. In the case where the received packet is an ordinary user packet, the control apparatus 40 transfers the received packet to the succeeding communication apparatus 20-5 on the communication path, as shown with an arrow P1. In the case where the received packet is a control packet 60, the control apparatus 40 terminates the received packet, and updates (adds a new entry or changes the contents of an existing entry) the data base 41, based on communication control information described in the payload of the received packet 60 and the topology information or the link status information stored in the data base 41, as shown with an arrow P2. If the contents of the data base 41 are changed, the changed information are broadcasted and reflected in other data bases 30 (30-1 to 30-5) which belong to the control plane 102, in accordance with the above-described routing protocol.

Each of the communication apparatuses 20 (20-1 to 20-5) sets a communication path peculiar to each user in the communication network 100 according to a signaling protocol of GMPLS (Generalized Multi-Protocol Label Switching) or the like, based on the control information specified by a corresponding data base 30 (30-1 to 30-5). Thus, according to the embodiment, user packets received thereafter from the terminal 10A-1 are controlled to transfer along the communication path, thereby realizing packet transfer in conformity with user-request QoS.

### Second Embodiment

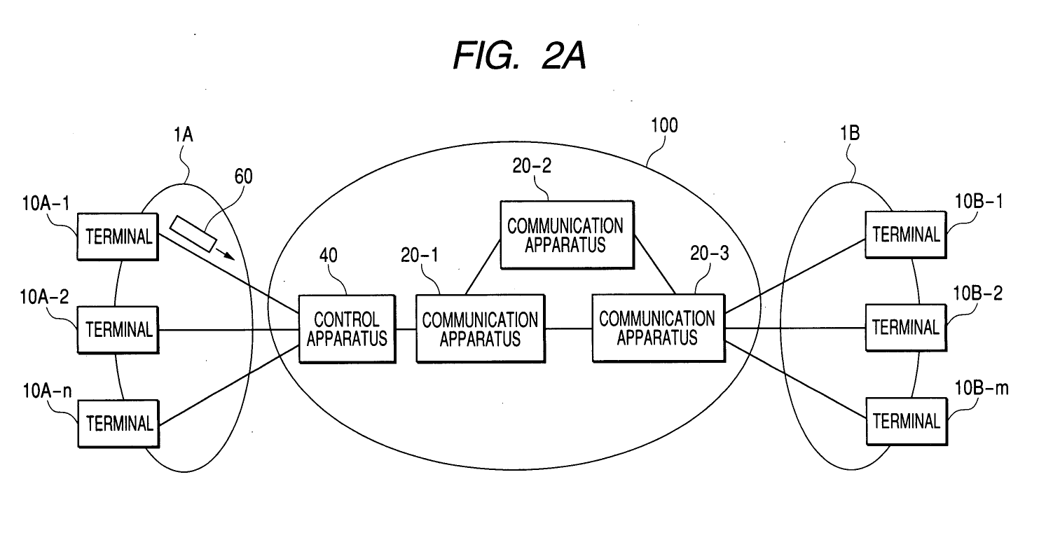

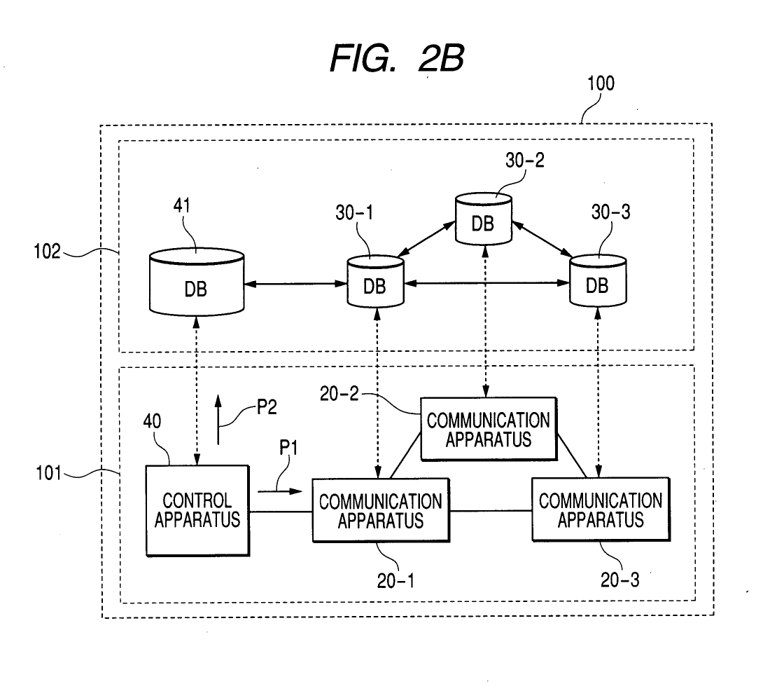

FIG. 2A shows a network configuration wherein the control apparatus 40 shown in FIGS. 1A and 1B is installed as an edge node of the communication network 100.

In this embodiment, the control apparatus 40 and the terminals 10A (10A-1 to 10A-n) are connected with each other physically via an electrical cable, such as an ADSL (Asynchronous Digital Subscriber Line), etc. or an optical fiber, so as to establish communication between the node apparatuses using a communication protocol, such as Ethernet (a registered trademark), SONET (Synchronous Optical Network), etc.

As shown in FIG. 2B, the control apparatus 40 and the communication apparatuses 20 (20-1 to 20-2) can logically be separated into the data plane 101 and the control plane 102, like FIG. 1B. The contents of the data bases 41 and 30 (30-1 to 30-2) which belong to the control plane 102 are appropriately updated in accordance with a predetermined routing protocol like the case of the first embodiment. Hence, the node apparatuses of the communication network 100 have the same packet transfer control information as each other.

Each terminal 10A (10A-1 to 10B-m) in the access networks 1 (1A, 1B) transmits a control packet 60 including communication control information specified by a user in its payload part, to a destination communication apparatus, for example, as shown by the illustration of the terminal 10A-1, prior to packet communication with the destination communication apparatus, likewise FIGS. 1A and 1B.

Upon receiving a packet, the control apparatus 40 analyzes the packet header of the received packet. Like the case of the first embodiment, in the case where the received packet is an ordinary user packet, the control apparatus 40 transfers the packet to the succeeding communication apparatus 20-1 on the communication path. In the case where the received packet is the control packet 60, the control apparatus 40 updates the data base 41, based on the communication control information described in the payload of the received packet 60, the topology information and the link status information of the communication network 100. The updated information of the data base is reflected in all other data bases 30 in the control plane 102.

The control apparatus 40 sets a communication path peculiar to each user for communication with another communication apparatus 30 along the user packet path, using a signaling protocol of GMPLS (Generalized Multi-Protocol Label Switching), etc. In this embodiment, as well, each node apparatus in the communication network 100 transfers the received packet transmitted from the terminal 10A-1 along the communication path, thereby realizing the QoS guarantee in conformity with a user request.

### Third Embodiment

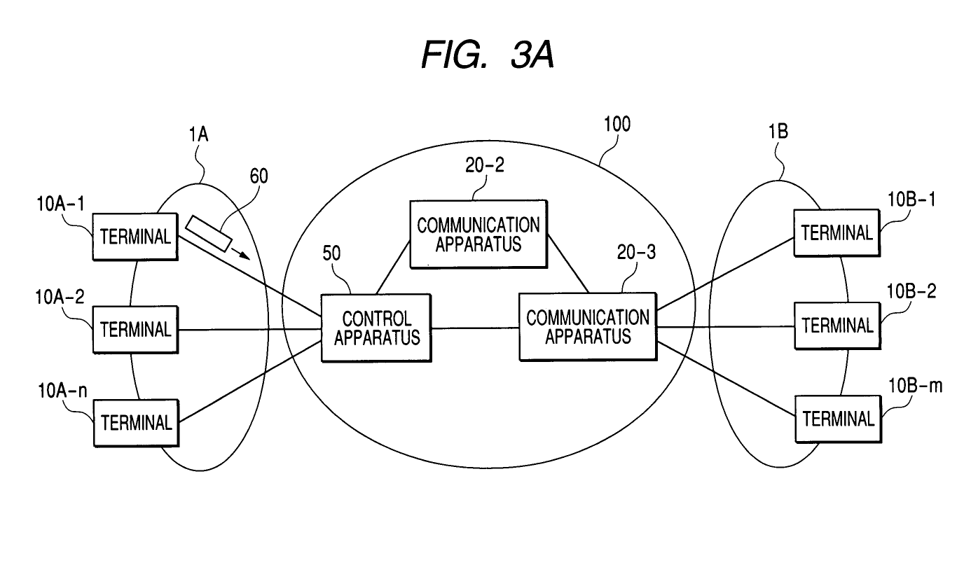

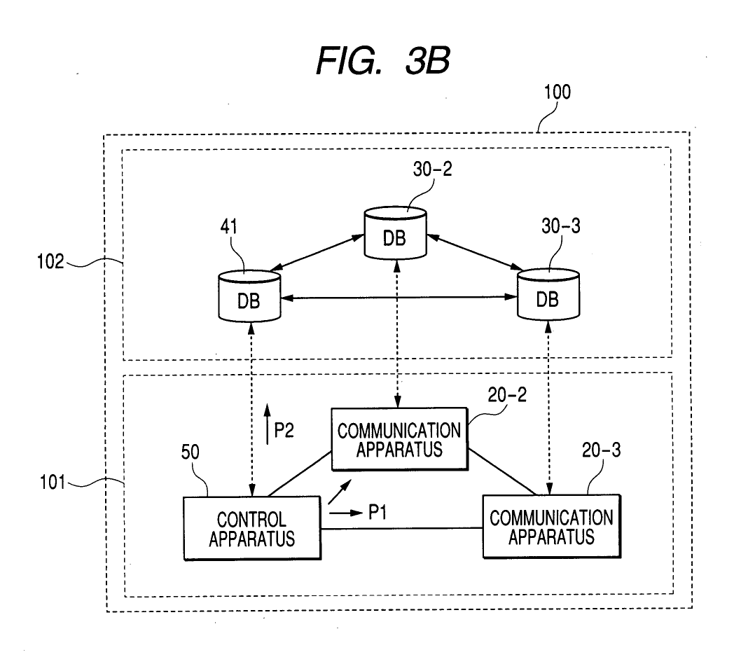

FIG. 3A shows a network configuration including a control apparatus 50 having both a packet routing function that the communication apparatus 20-1 has and a function of immediate setting packet transfer control information. The immediate setting function is that realized in the control apparatus 40 of FIGS. 2A and 2B. The control apparatus 50 performs routing transfer of user packets to be transmitted and received by the terminals 10A-1 to 10A-n in the access network 1A in accordance with the header information, like the case of the communication apparatus 20-1.

As shown in FIG. 3B, like the first and second embodiments, upon receiving the control packet 60 including communication control information in its payload part, the control apparatus 50 updates the data base 41 and reflects the updated information in other data bases of the control plane 102. Thus, in this embodiment, as well as the first and second embodiments, the QoS guarantee in conformity with a user request can be realized.

### Fourth Embodiment

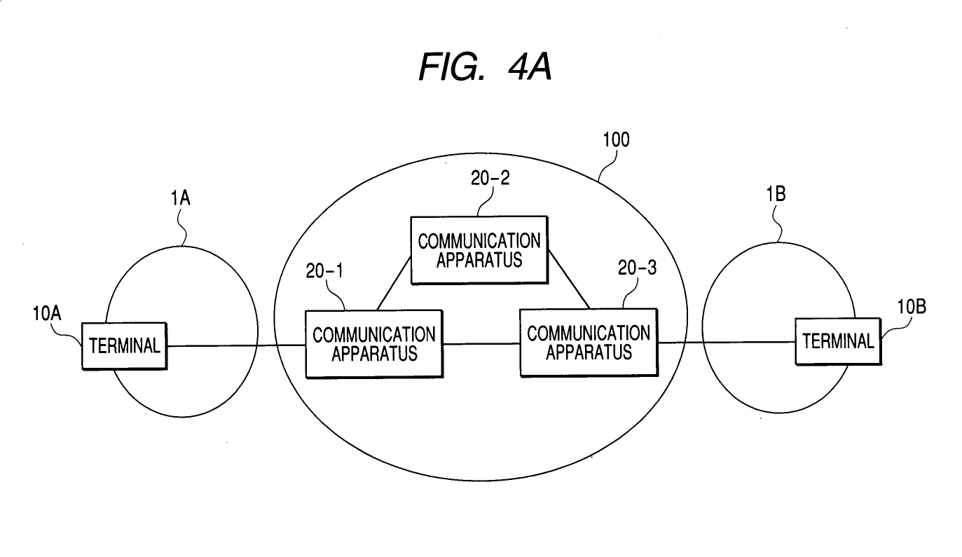

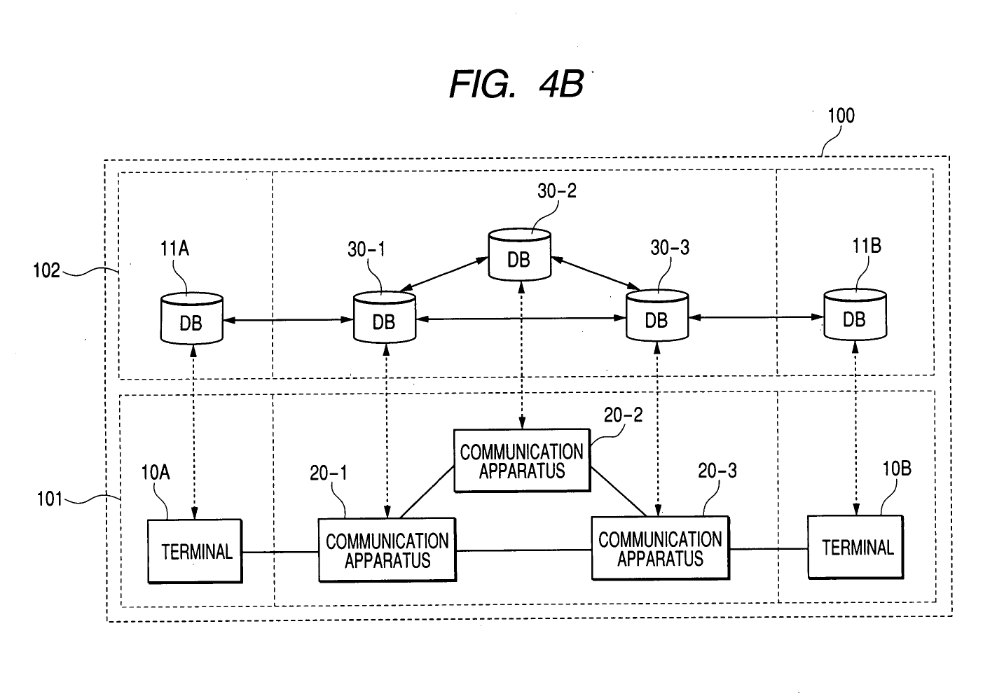

FIG. 4A shows a network configuration wherein each of user terminals in the access network is provided with a data base for storing packet transfer control information. In this embodiment, as illustrated in FIG. 4B, the control plane 102 includes data bases 11A and 11B corresponding to the terminals 10A and 10B, respectively. Control information is synchronized among the data bases 11A and 11B and the data bases 30 (30-1 to 30-3) in the communication network 100, using a routing protocol, such as an RIP, OSPF, etc.

If a user of the terminal 10A in the access network 1A selects a communication service, prior to data communication with the user terminal 10B in the access network 1B, for example, the user terminal 10A updates the data base 11A, like the performance of the control apparatus 40 in the first embodiment. The updated information of the packet transfer control information is broadcasted to the rest of the data bases 30 (30-1 to 30-3) and 11B which belong to the same control plane 102 as the data base 11A, and reflected in each of the data bases. Thus, each of the communication apparatuses 20 (20-1 to 20-3) sets a communication path peculiar to the user terminal 10A in the communication network 100 based on the contents of its corresponding data base 30, and transfers user packets from the terminal 10A to the terminal 10B along the communication path, thereby realizing a predetermined QoS that the user of the terminal 10A desires.

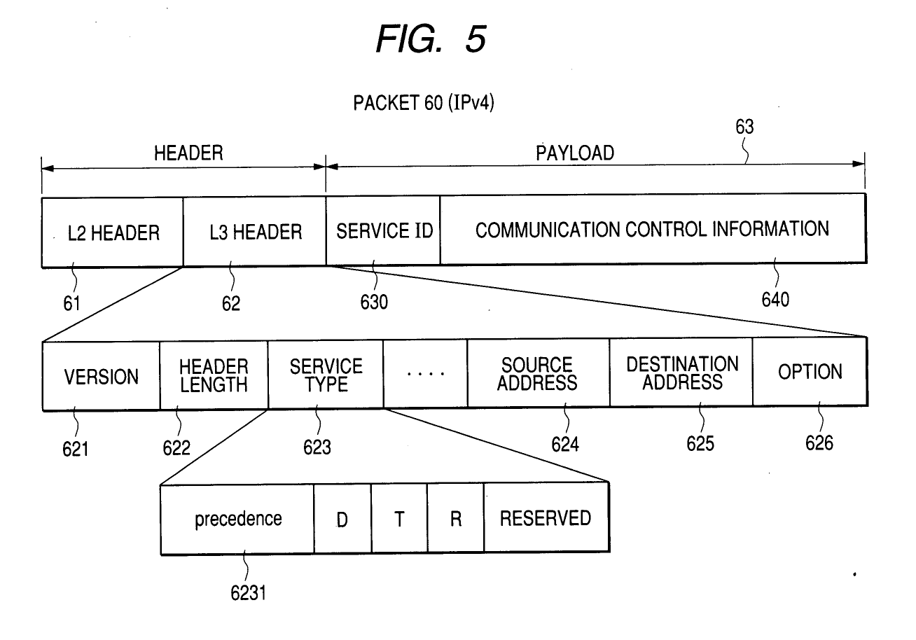

FIG. 5 exemplifies a format of a packet 60(IPv4) of IPv4 version that is used as the control packet 60. The control packet 60 (IPv4) is composed of an L2 header 61 including header information of the second layer (data link layer) of the OSI reference model, an L3 header 62 including header information of the second layer (network layer), and a payload 63. The payload 63 includes a service ID 630 specifying a user selected service and communication control information 640 which may defer depending on a service class.

The L3 header 62 includes fields of Version 621, Header Length 622, Service Type 623, Source Address 624, Destination Address 625 and Option 626, etc. The Service Type field 623 includes fields of “D” (Delay) “T” (Throughput), “R” (Reliability) and Reserved, following a three-bit precedence field 6231.

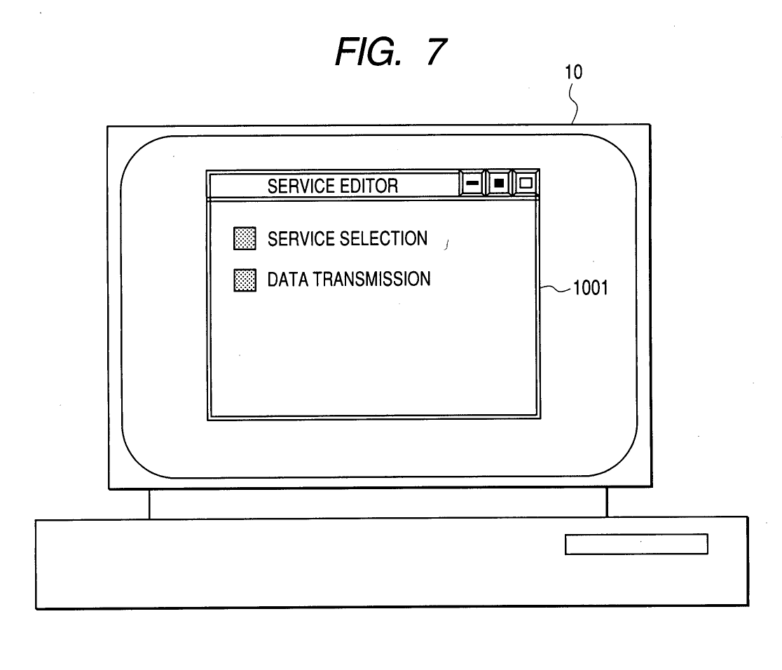

In this embodiment of the present invention, for example, the user of the terminal 10A-1 specifies on a terminal display, which will be explained later by referring to FIGS. 7 to 12, a communication service that he/she desires to execute, and performs input operations in accordance with the specified communication service on a menu window.

In response to such user operations, the terminal 10A-1 generates a packet including a service ID and communication control information in its payload part 63, an address of the terminal 10A-1 and an address of the destination terminal respectively as the Source Address 624 and the Destination Address 625, and a predetermined bit pattern in the precedence field 6231. Then, the terminal 10A-1 transmits the generated packet to the communication network 100 as the above described control packet 60. In the case where the communication network 100 is an IPv4 network, the control apparatus 40 (or 50) analyzes the header of the received packet. If the received packet is one having a predetermined flag bit in the precedence field 6231, the control apparatus 40 identifies the packet as a control packet, and updates the data base 41.

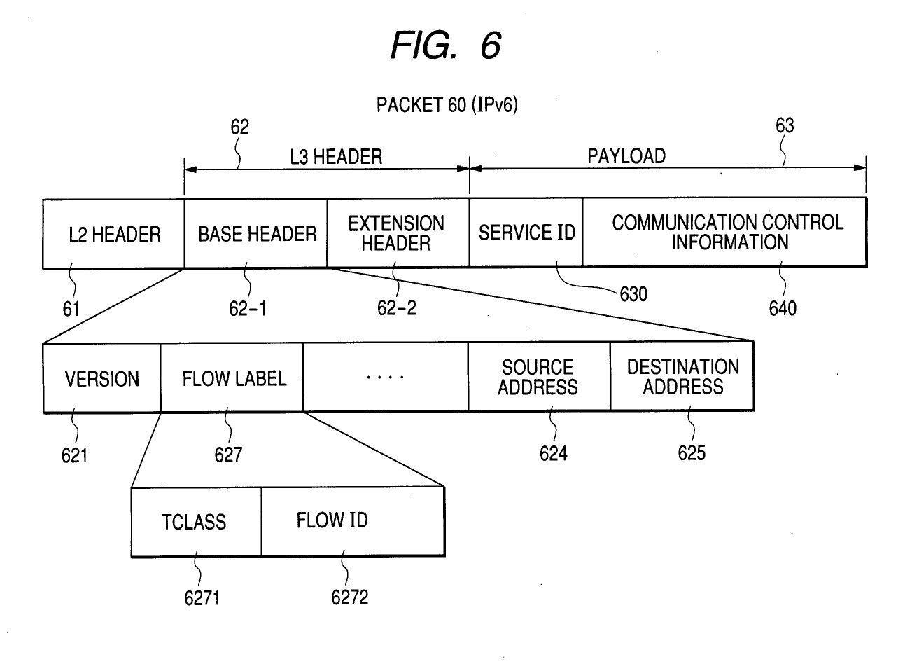

FIG. 6 exemplifies a format of a packet 60 (IPv6) of IPv6 version that is used as a control packet. In the packet 60 (IPv6), the L2 header 62 is composed of a base header 62-1 and an extension header 62-2, and the base header 62-1 includes a flow label 627. The flow label 627 is composed of a four-bit of TCALASS field 6271 and Flow ID field 6272.

When the user of the terminal 10A-1 specifies a communication service that he/she desires to execute and performs input operations in accordance with the specified communication service on the menu window of the terminal screen, the terminal 10A-1 generates a packet including a service ID and communication control information in the payload part 63, an address of the terminal 10A-1 and an address of the destination terminal as the source address 624 and the destination address 625, respectively, and a predetermined bit pattern in the TCLASS field. Then, the terminal 10A-1 transmits the packet to the communication network 100 as the control packet 60.

In the case where the communication network 100 is an IPv6 network, the control apparatus 40 (or 50) analyzes the header of the received packet. If the received packet is one having a predetermined flag bits in the TCLASS field 6271, the terminal 10A-1 identifies the received packet as the control packet, and updates the data base 41.

FIG. 7 exemplifies an initial screen of a service editor 1001 which is displayed on the terminal 10A-1. The service editor 1001 includes a service selection button and a data transmission button. The user selects the service selection button, and inputs information necessary for bandwidth control as will be explained hereinafter. After that, the user selects the data transmission button so as to transmit the data.

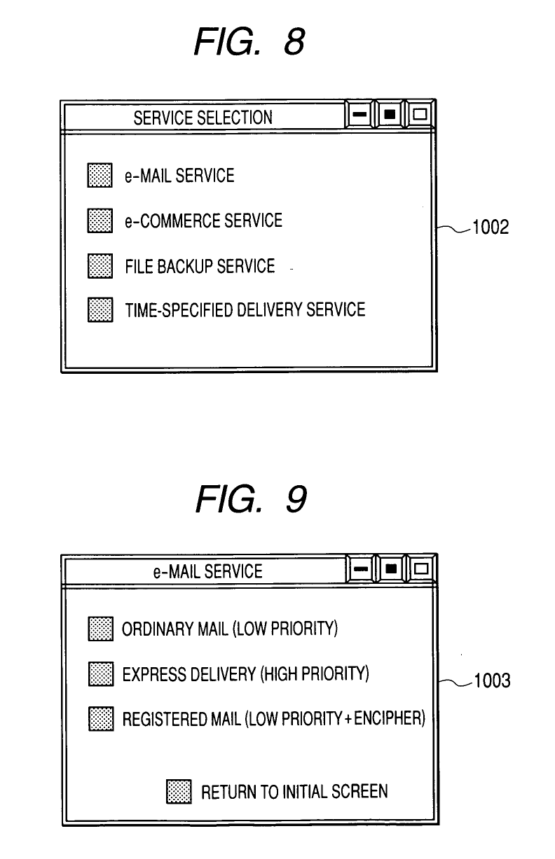

FIG. 8 exemplifies a service selection window 1002 displayed in response to a clicking operation on the service selection button. Here, an e-mail service, an e-commerce service, a file backup service and a time-specified delivery service are prepared as user selectable services.

FIG. 9 exemplifies a menu window 1003 displayed when the user selects the e-mail service on the service selection window 1002. An ordinary mail (ordinary delivery) service, an express delivery service, a registered mail (registered delivery) service are prepared as the user selectable services in the e-mail service menu. The ordinary delivery service corresponds to a low-priority service without encryption processing, the express delivery service corresponds to a high-priority service with encryption processing, and the registered delivery service corresponds to a low-priority service with encryption processing.

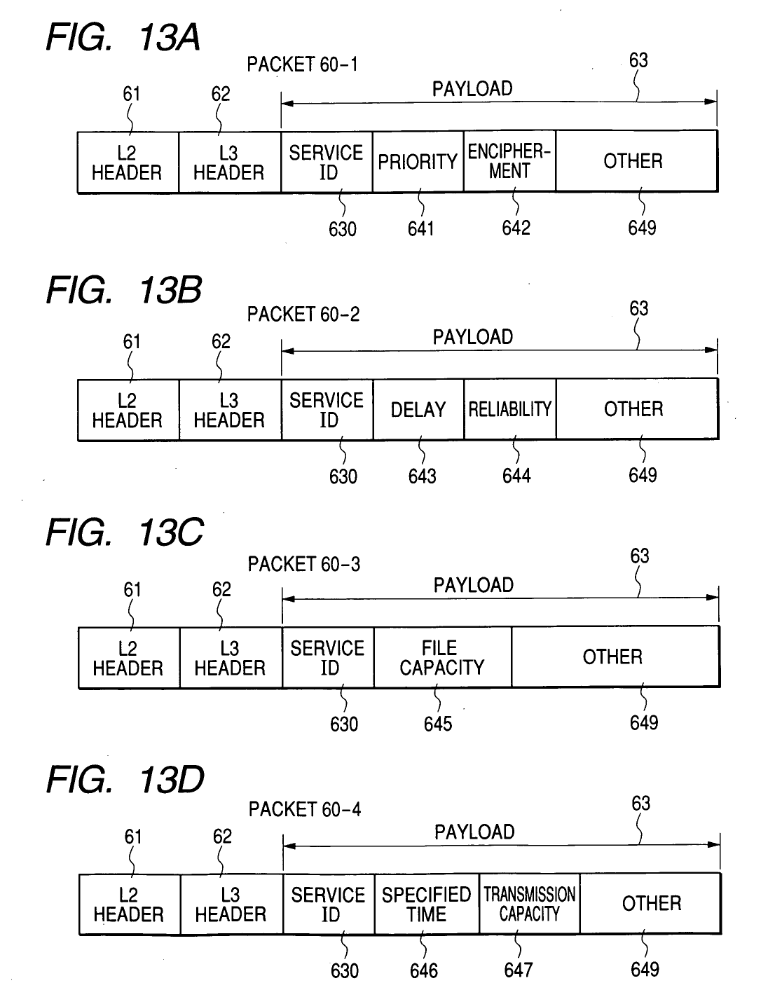

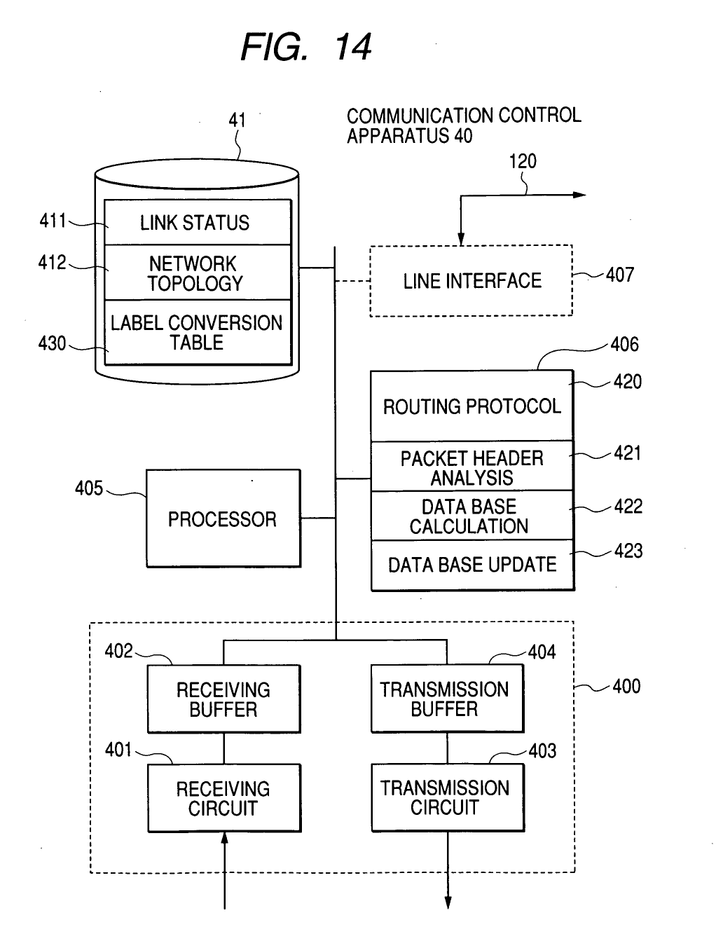

When the user completes the input operation on the menu window 1003 and selects the data transmission button on the initial screen 1001, the terminal 10A-1 generates a control packet 60-1 shown in FIG. 13A, and transmits the generated packet to the communication network 100. As a result of above operations, the terminal user is able to transmit an e-mail to a destination terminal.

As shown in FIG. 13A, the control packet 60-1 includes, in its payload 63, a Service ID 630 specifying an e-mail service, and communication control information specifying Priority 641 and Necessity/Non-necessity of Encryption Processing 642 and Other Information 649 as needed.

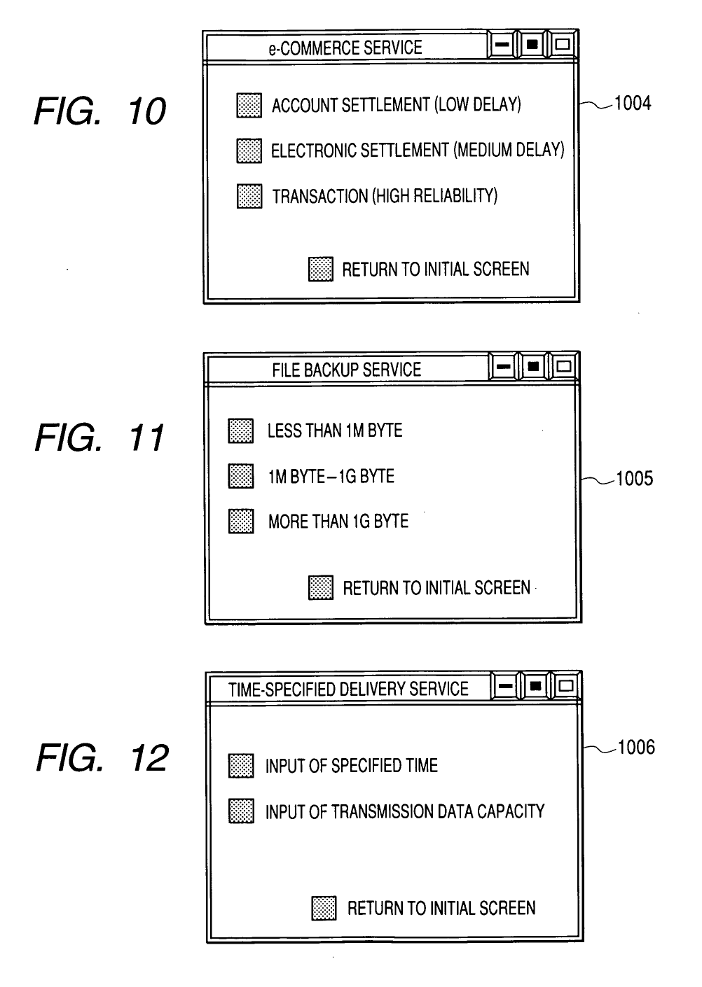

FIG. 10 exemplifies a menu window 1004 displayed when the user selects an e-commerce service on the service selection window 1002. User selectable services in the e-commerce service include an account settlement service, an electronic settlement service and a transaction service. The account settlement service corresponds to a low reliability low delay service, the electronic settlement service corresponds to a low reliability medium delay service, and the transaction service corresponds to a high reliability medium delay service.

When the user completes the input operation on the menu window 1004 and selects the data transmission button on the initial screen 1001, the terminal 10A-1 generates a control packet 60-2 shown in FIG. 13B, and transmits the generated packet to the communication network 100. As a result of the above operations, the terminal user can begin data communication for e-commerce processing.

As shown in FIG.13B, the control packet 60-2 includes, in its payload 63, the Service ID 630 specifying an e-commerce service, and the communication control information specifying degree of Delay 643 and Reliability 644 and Other Information 649 as needed.

FIG. 11 exemplifies a menu window 1005 displayed when the user selects the file backup service on the service selection window 1002. In the file backup service, user selectable services are a service for less than 1 MB (megabyte) data, a service for 1 MB data to 1 GB (gigabyte) data, a service for more than 1 GB data.

When the user completes the input operation on the menu window 1005 and selects the data transmission button on the initial screen 1001, the terminal 10A-1 generates a control packet 60-3 shown in FIG. 13C, and transmits the generated packet to the communication network 100. As a result of the above operations, the terminal user can start data communication for file backup processing.

As shown in FIG.13C, the control packet 60-3 includes, in its payload 63, the service ID 630 specifying the file backup service, and the communication control information specifying File Capacity 645, and Other Information 649 as needed.

FIG. 12 exemplifies a menu window 1006 displayed when the user selects the time-specified delivery service on the service selection window 1002. In the time-specified delivery service, the user inputs the specified time and transmission data capacity.

When the user completes the input operation on the menu window 1006 and selects the data transmission button on the initial screen 1001, the terminal 10A-1 generates a control packet 60-4 shown in FIG. 13D, and transmits the generated packet to the communication network 100. As a result of the above operations, the terminal user can start data communication for the time-specified delivery processing.

As shown in FIG. 13D, the control packet 60-4 includes, in its payload 63, the Service ID 630 specifying the time-specified delivery service, and communication control information specifying Specified Time 646 and Transmission Capacity 647, and Other Information 649 as needed.

In this embodiment, the control apparatus 40 (or 50) checks the Precedence field 6231 or TCLASS field 6271 of the received packet. If, for example, the least significant bit is “1”, the control apparatus 40 determines the received packet as a control packet and updates the data base. On the other hand, if the least significant bit is “0”, the control apparatus 40 transfers the received packet to the succeeding communication apparatus in accordance with the destination address 625.

FIG. 14 exemplifies a block configuration of the control apparatus 40.

The control apparatus 40 comprises a circuit interface 400 to be connected to the access network 1 or the communication network 100, a processor 405, a memory 406 and the database 41. The circuit interface 400 is composed of a receiving circuit 401 connected to an input line, a receiving buffer 402 for temporarily storing received packets, a transmission circuit 403 connected to an output line, and a transmission buffer 404 for temporarily storing transmission packets.

The data base 41 stores a link status table 411 necessary for controlling packet transfer, a network topology table 412, a label conversion table 430 as will be explained later, and the other tables. The link status table 411 shows, for example, the status of traffic, path bandwidth, the coefficient of utilization of the bandwidth, a normal/fault state of the line, etc. according to each rout in the communication network 100.

The memory 406 stores various programs to be executed by the processor 405. In this embodiment, those programs that are relevant to the present invention may include a routine 420 for a communication protocol (a routing protocol), such as an OSPF, LMP (Link Management Protocol), a packet header analyzing routine 421, a data base calculation routine 422 and a data base updating routine 423.

The processor 405 reads out a received packet from the receiving buffer 402 in accordance with the packet header analyzing routine 421, and checks the least significant bit of the Precedence field 6231 or the TCLASS field 6271 in the received packet. In the case where the least significant bit is “0”, the processor 405 determines that the received packet is an ordinary user packet, and transfers the packet to the transmission buffer 404. The packet stored in the transmission buffer 404 is sent out to the output line by the transmission circuit 403.

In the case where the least significant bit of the Precedence field 6231 or the TCLASS field 6271 of the received packet is “1”, the processor 405 determines that the packet is the control packet 60 issued by the user terminal, and executes the data base calculation routine 422.

The data base calculation routine 422 analyzes the payload 63 based on the service ID 630 specified in the received packet 60 (60-1 to 60-4), and extracts communication control parameter values specified by the user terminal. The data base calculation routine 422 is so executed as to obtain control parameter values necessary for setting a path suitable for the user needs, such as label information, a bandwidth to be secured and the like, based on the communication control parameter values by referring to the link status table 411 and the network topology table 412 of the data base 41. Thereafter, by executing a data base updating routine 423, the processor 405 converts those parameter values in the entry format suitable for the configuration of the label conversion table 430, and adds the converted values into the label conversion table 430 (i.e., updates the data base 41).

The processor 405 parallelly executes the packet header analyzing routine 421 and the routing protocol routine 420. If the updating of the data base 41 is detected, the routing protocol routine 420 generates a broadcast (advertisement) packet for reflecting the updated information in other data bases in the communication network 100, and outputs the generated packet to the transmission buffer 404. As shown by a broken line in the illustration, a second circuit interface 407 connected to a dedicated line 120 may be provided, so that the broadcast packet is output to the circuit interface 407, thereby to broadcast the packet to other data bases through the dedicated line.

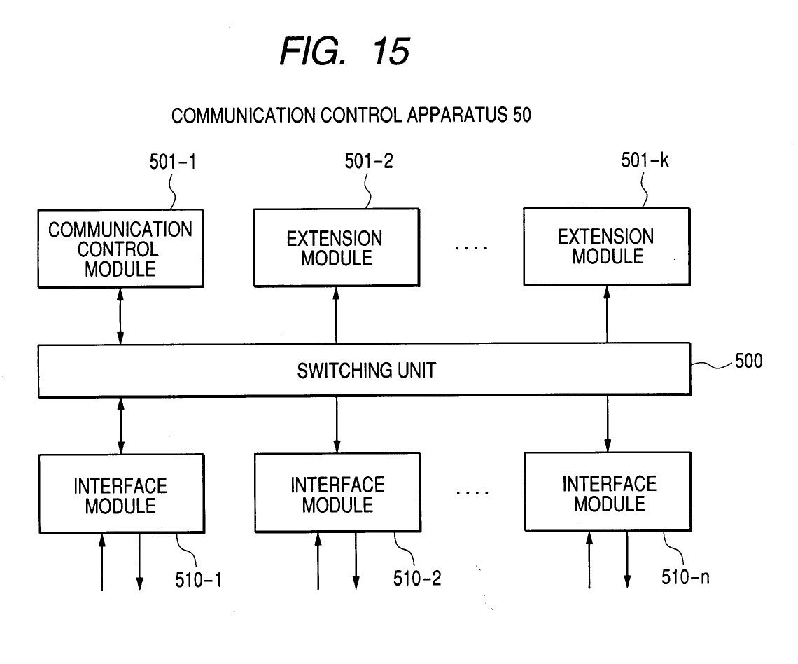

FIG. 15 exemplifies a block configuration of the communication control apparatus 50 having a packet routing function. In FIG. 15, functions of the control apparatus 40 are incorporated into the router.

The control apparatus 50 comprises a plurality of extension modules 501 (501-1 to 501-k) and a plurality of interface modules 510 (510-1 to 510-n) which are connected with each other through a switching unit 500. In this embodiment, the control apparatus 40 shown in FIG. 14 is connected to the switching unit 500 as one extension module 501 (a communication control module 501-1). The control packet 60 received by one of the interface modules 510 is input to the communication control module 501-1 through the switching unit 500. A broadcast packet for routing information advertisement generated by the communication control module 501-1 is transmitted to other communication node apparatuses through the switching unit 500 and the interface modules 510.

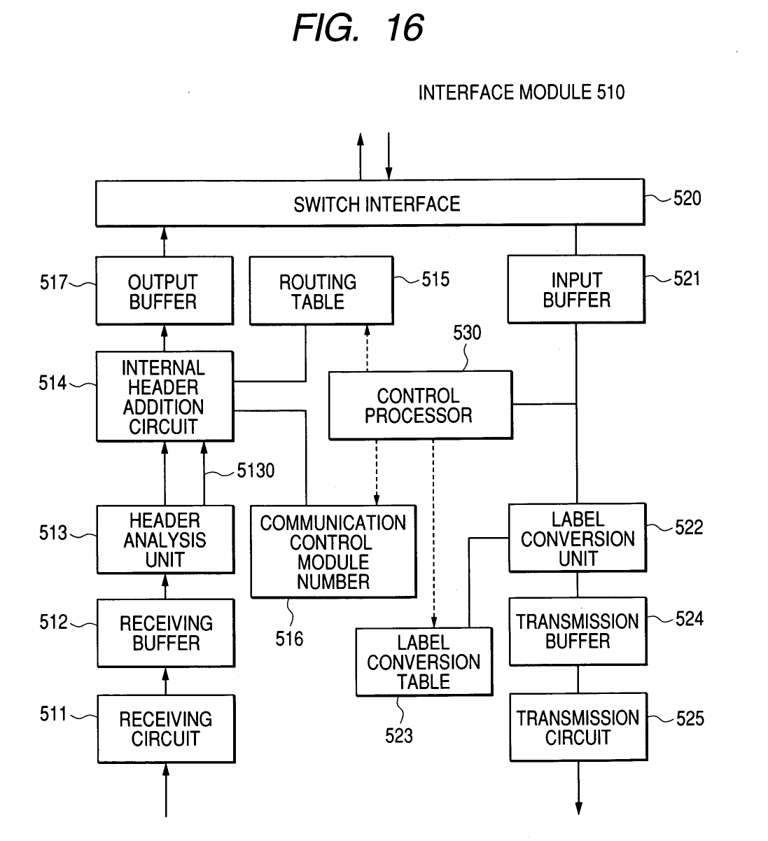

FIG. 16 exemplifies a block configuration of the interface module 510.

The interface module 510 includes a receiving circuit 511 connected to an input line, a receiving buffer 512 and a header analysis unit 513. The receiving buffer 512 temporarily stores a received packet output from the receiving circuit 511. The header analysis unit 513 analyzes the header of the received packet read out from the receiving buffer 512, and determines whether this packet is an ordinary user packet or a control packet.

The header analysis unit 513 determines that the received packet is a control packet 60 issued by the user terminal, if the least significant bit of the Precedence field 6231 or the TCLASS field 6271 in the received packet is “1”. Then, the header analysis unit 513 outputs the received packet to an internal header addition circuit 514, and outputs an ON signal to a signal line 5130. On the contrary, if both the least significant bits of the above fields are “0”, the header analysis unit 513 determines that the received packet is an ordinary user packet, and outputs the received packet to the internal header addition circuit 514 while the signal line 5130 is still OFF.

While the signal line 5130 is OFF, the internal header addition circuit 514 searches a routing table 515 based on a destination address (or label information) of the received packet, for a module number (internal routing information) specified in a table entry corresponding to the destination address. Then, the internal header additional circuit 514 adds the module number to the received packet, and outputs the packet to an output buffer 517. While the signal line 5130 is ON, the internal header addition circuit 514 adds a module number (internal routing information) of the communication control module 501-1 which is specified by a register 516 to the received packet, and outputs the packet having the module number to the output buffer 517.

The packet stored in the output buffer 517 is output to the switching unit 500 through a switch interface 520. The switching unit 500 transfers the received packet to a module corresponding to the module number added to the received packet as the internal routing information. As a result, the control packet 60 is transferred to the communication control module 501-1, and processed in accordance with the procedure explained by referring to FIG. 14. The ordinary user packet is transferred to any of the interface modules corresponding to the module number added to the packet as the internal routing information.

The interface module 510 receives the packet output from the switching unit 500 through the switch interface 520, and stores the received packet in an input buffer 521. The stored packet is read out from the input buffer 521 by a label conversion unit 522. After removing unnecessary module number from the packet, the label conversion unit 522 performs label processing which may include adding/converting/deleting of a label in accordance with a label conversion table 523. The packet output from the label conversion unit 522 is sent out to an output line through a transmission buffer 524 and a transmission circuit 525.

The routing table 515, the register 516 and the label conversion table 523 are connected to a control processor 530. In the case where the label conversion table 430 of the data base 41 is updated, the control processor 530 updates the contents of the label conversion table 523, in response to a table updating instruction issued from the communication control module 501-1 (control apparatus 40). The table updating instruction may be issued in a format of an internal control packet, addressed to the control processor 530 from the routing protocol routine 420. Alternatively, the control processor 530 may monitor the broadcast packet, and update the label conversion table 523 based on the contents of the broadcast packet.

The following describes the specific application of the control apparatus according to the present invention.

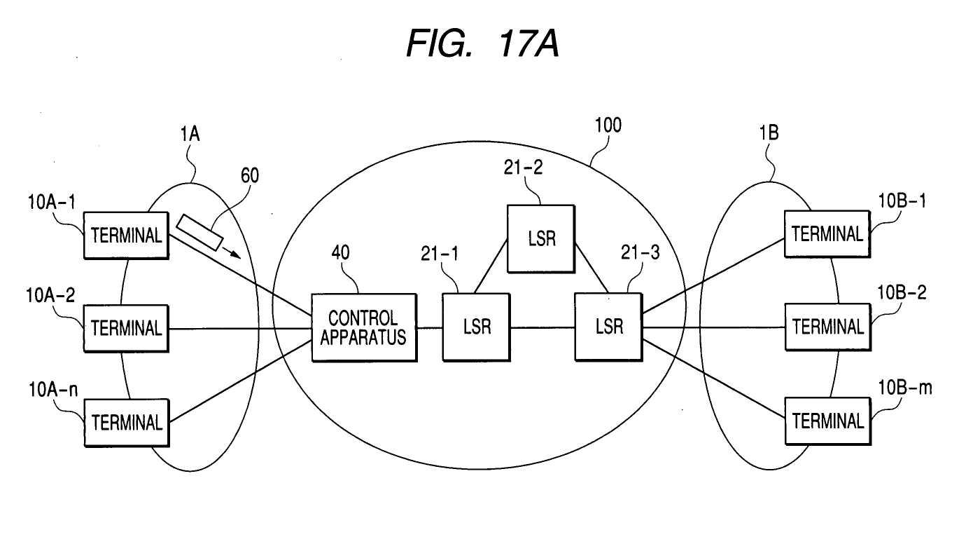

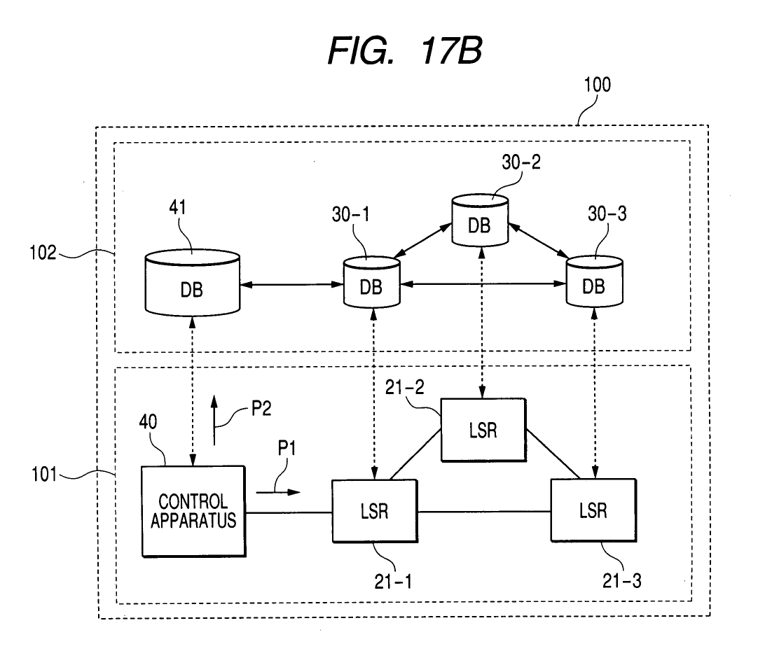

FIG. 17A shows a network configuration wherein the control apparatus 40 according to the present invention is applied to a communication network comprising of MPLS routers. The communication network 100 is composed of the control apparatus 40 and a plurality of Label Switch Routers (LSR) 21 (21-1 to 21-3), and is connected to the access networks 1A and 1B through a communication line, such as Ethernet, etc.

The communication network 100 is, logically, separated into the data plane 101 and the control plane 102, as shown in FIG. 17B. A plurality of data bases 41 and 30-1 to 30-3 associated with the control apparatus 40 and the LSRs 21 belong to the control plane 102. Synchronization and updating of information are performed in those data bases in an autonomous distribution manner.

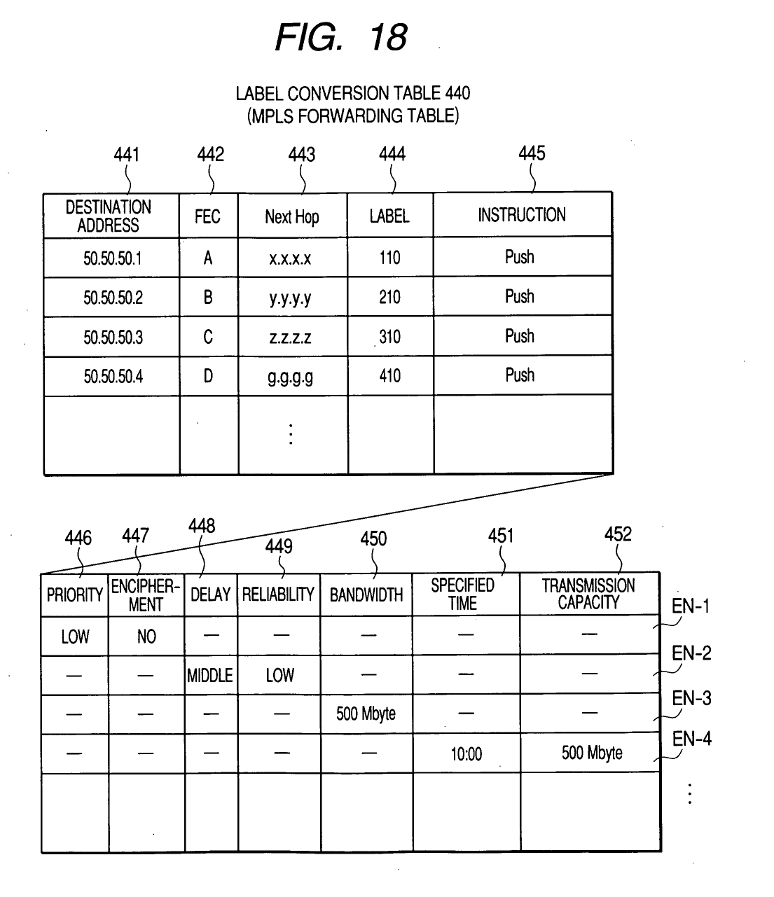

FIG. 18 exemplifies a configuration of an MPLS forwarding table 440 provided in the data base 41 of the control apparatus 40 as the label conversion table 430.

Each table entry of the MPLS forwarding table 440 includes, as common item information, Destination Address 441, FEC (Forwarding Equivalent Class) 442, Next Hop 443, Label 444 and Instruction 445. Item information dependent on the type of service selected by the user includes Priority 446, Necessity/Non-necessity of Encryption Processing 447, Degree of Delay 448, Reliability 449, Bandwidth 450, Specified Time 451 and Transmission Capacity 452.

The values of the FEC 442, Next Hop 443 and Label 444 are determined by the data base calculation routine 422, in accordance with a predetermined calculation algorithm based on the contents of the link status table 411, the network topology table 412 and the service dependent item information in the control packet 60. In the illustrated example, an entry EN-1 is generated, upon reception of the control packet 60-1, and entries EN-2, EN-3 and EN-4 are generated, respectively upon reception of the control packets 60-2, 60-3 and 60-4.

Like this embodiment, in the case where the node apparatus 20 in the communication network 100 are LSRs, the contents of a new entry that the control apparatus 40 has added into the MPLS forwarding table 440 is distributed to each LSR 21 (21-1 to 21-3) in the communication network 100, using a protocol, such as an LDP (Label Distribution Protocol), an RSVP-TE (Resource Reservation Protocol-Traffic Engineering), etc. An explicit PSC-LSP (Packet Switch Capable-Label Switched Path) can be set in the communication network 100, using, for example, a GMPLS signaling function based on the added entry.

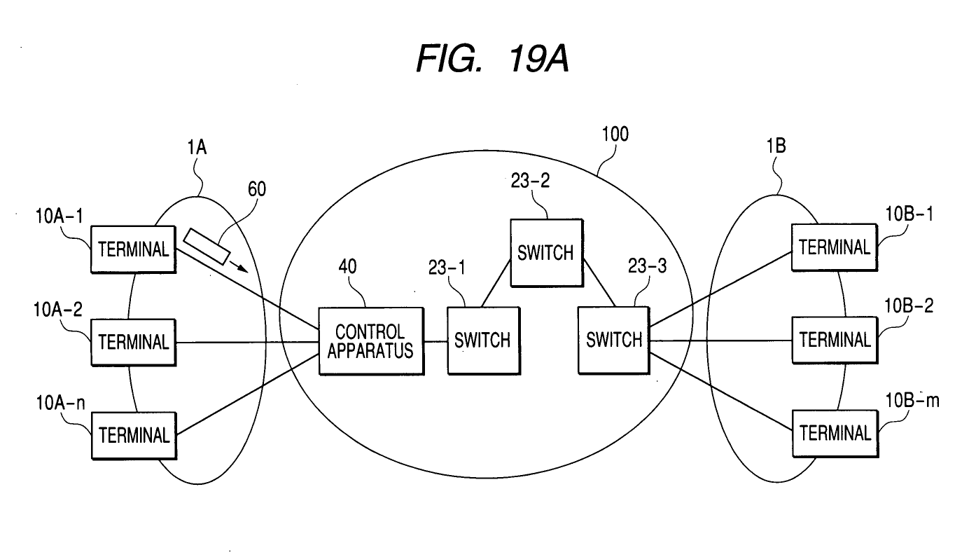

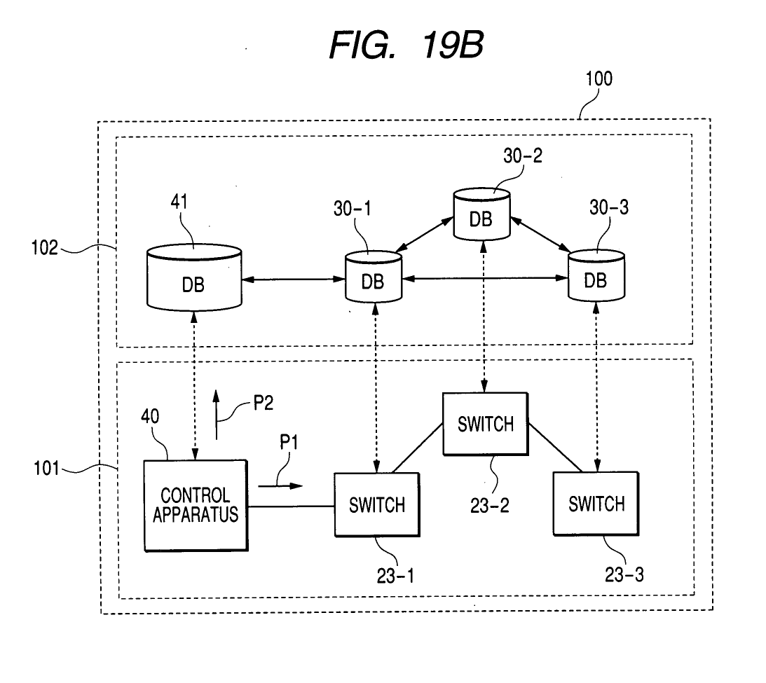

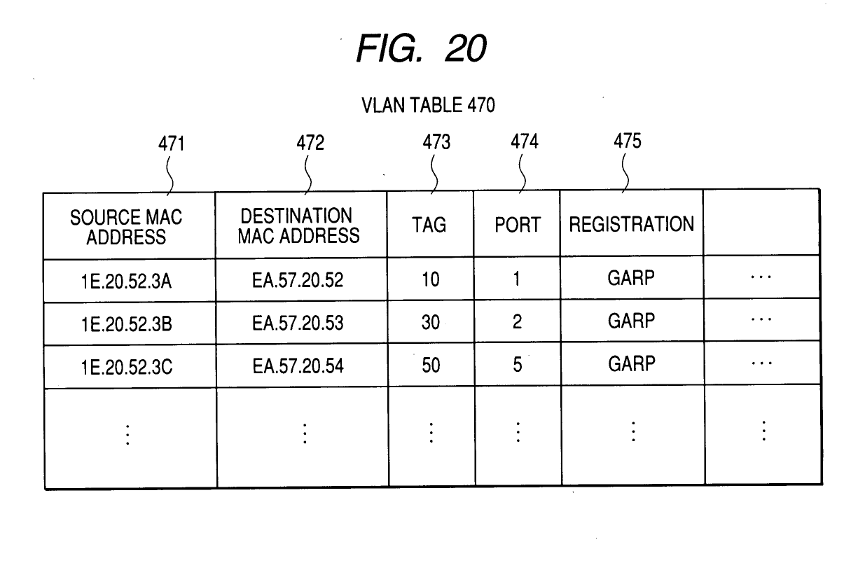

By referring to FIGS. 19A and 19B and FIG. 20, description will be made to a case where a VLAN is formed in the communication network 100.

FIG. 19A shows a network configuration including the communication network 100 according to this embodiment and the access networks 1A and 1B. FIG. 19B shows a logical configuration of the communication network 100. The communication network 100 comprises the control apparatus 40 and a plurality of LAN switches 23 (23-1 to 23-3) respectively including the data bases 30 (30-1 to 30-3). In this embodiment, the communication network 100 is connected to the access networks 1A, 1B through communication lines, such as Ethernet, etc. Each LAN switch 23 forms a spanning tree defined by IEEE802.1Q.

FIG. 20 shows the main part of the VLAN table 470 which is formed as the label conversion table 430 in the data base 41. Each entry of the VLAN table 470 includes, as common item information, Source MAC Address 471, Destination MAC Address 472, Tag 473, Port 474 and Registration 475. In addition, each entry includes the same information as that shown in FIG. 18, as item information dependent on the type of service that the user selected.

If the control apparatus 40 updates the VLAN table 470, the contents of the data base 41 are broadcasted to other data bases 30 (30-1 to 30-3) in the communication network, using a routing protocol, such as OSPF-TE, etc. defined in GMPLS, for example. An LSP of L2SC (Layer 2 Switch Capable) can be established between the LAN switches 23-1 to 23-3, using a signaling protocol RSVP-TE of GMPLS.

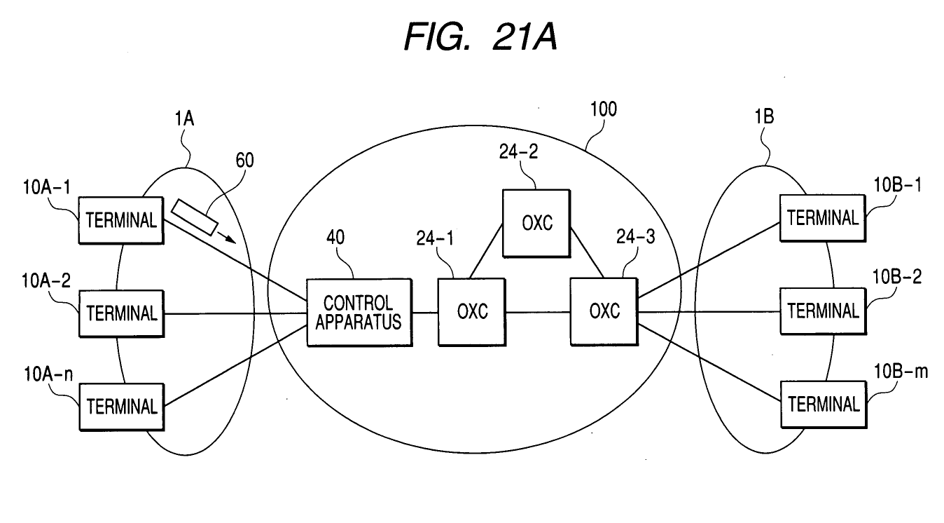

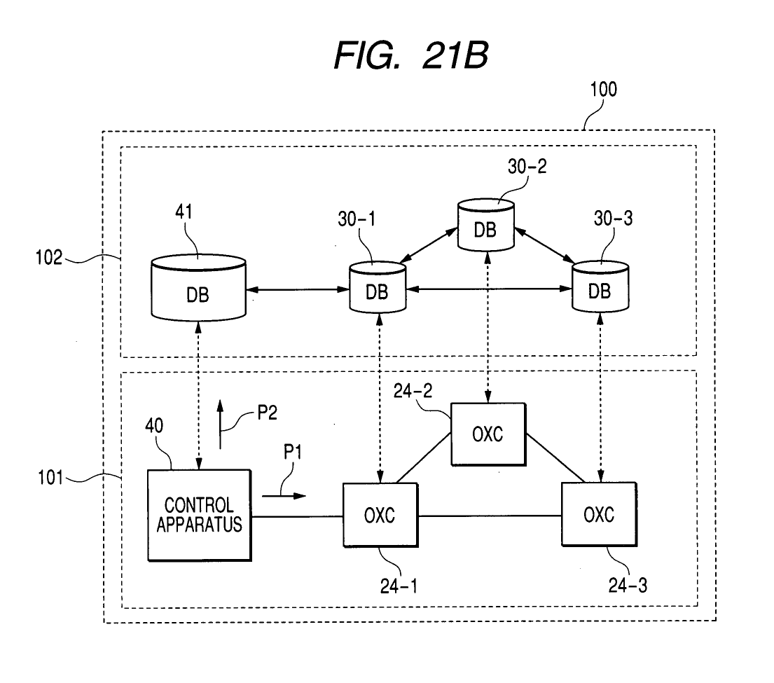

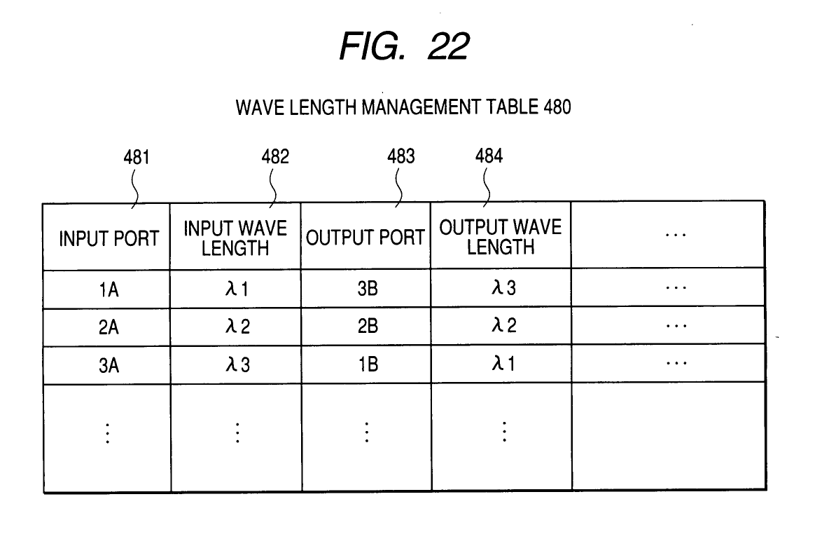

By referring to FIGS. 21 and 22, description will be made to a case where a path is set in optical cross-connect apparatuses in the communication network 100.

FIG. 21A shows the network configuration comprising the communication network 100 of this embodiment and the access networks 1A and 1B, and FIG. 21B shows a logical configuration of the communication network 100. The communication network 100 comprises the control apparatus 40 and a plurality of optical cross-connects (OXC) 24 which respectively include the data bases 30 (30-1 to 30-3). The communication network 100 and the access networks 1A and 1B are connected with each other through communication lines, such as Ethernet, etc.

FIG. 22 shows the main part of a wave length management table which is formed as the label conversion table in the data base 41.

Each entry of the wave length management table 480 includes, as common item information, Input Port 481, Input Wave Length 482, Output Port 483 and Output Wave Length 484. In addition, the same information as that shown in FIG. 18 is included as item information dependent on the type of service selected by the user.

The control apparatus 40 updates the wave length management table 480 and broadcasts the updated information to other data bases 30 (30-1 to 30-3) in the communication network 100, using a routing protocol, such as OSPF-TE, etc. of GMPLS, for example. An LSP of LSC (Lamda Switch Capable) can be set between the OXC 24-1 to 24-3, using a signaling protocol RSVP-TE of GMPLS. As described above, according to the present invention, a path can be established between the OXCs, based on the user specified information.

As explained, the control apparatus 40 (or 50) can create, in the data base 41, the label conversion table 430 in a format corresponding to the kind of node apparatus included in the communication network and the communication control information specified in the control packet 60. With the application of the present invention, a VPN can be established in the communication network 100 comprising, for example, a plurality of routers, in response to a user request. That is, the control apparatus 40 determines the number of Hops and the type of tunnel protocol to be used, by referring to, for example, the communication control information specified in the control packet 60, the link information table, the topology information table and the label conversion table prepared in the data base 41. Then, the control apparatus 40 stores the determined information in the VPN management table, in association with to an Ingress address and an Egress address of the user packet, together with the item information dependent on the type of service. By so doing, a VPN can be established in the communication network, using the signaling function of GMPLS.

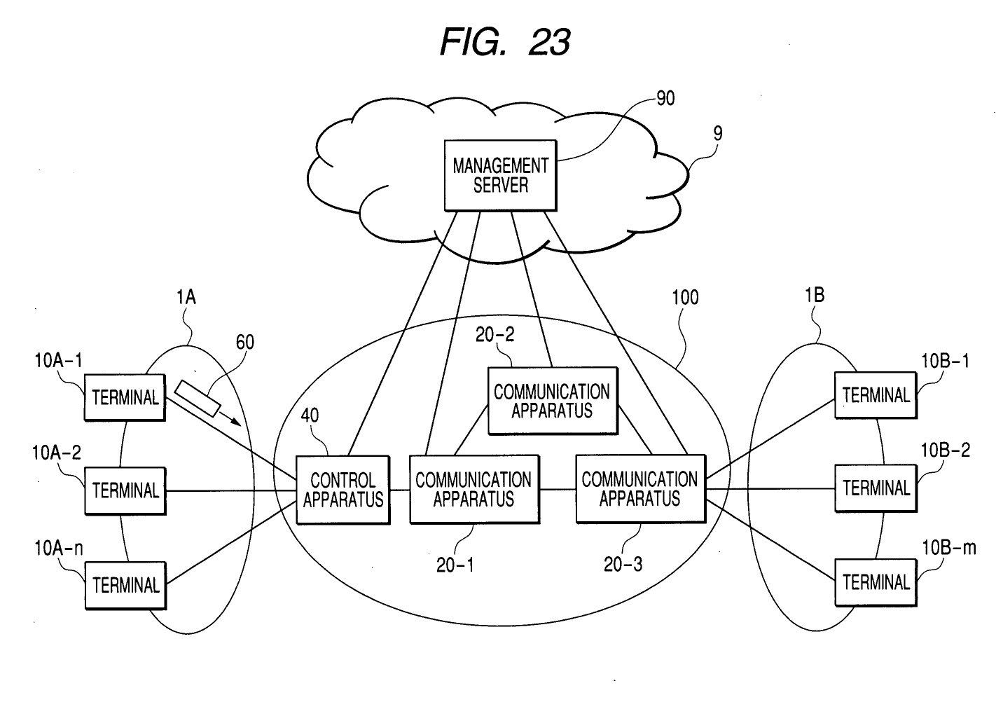

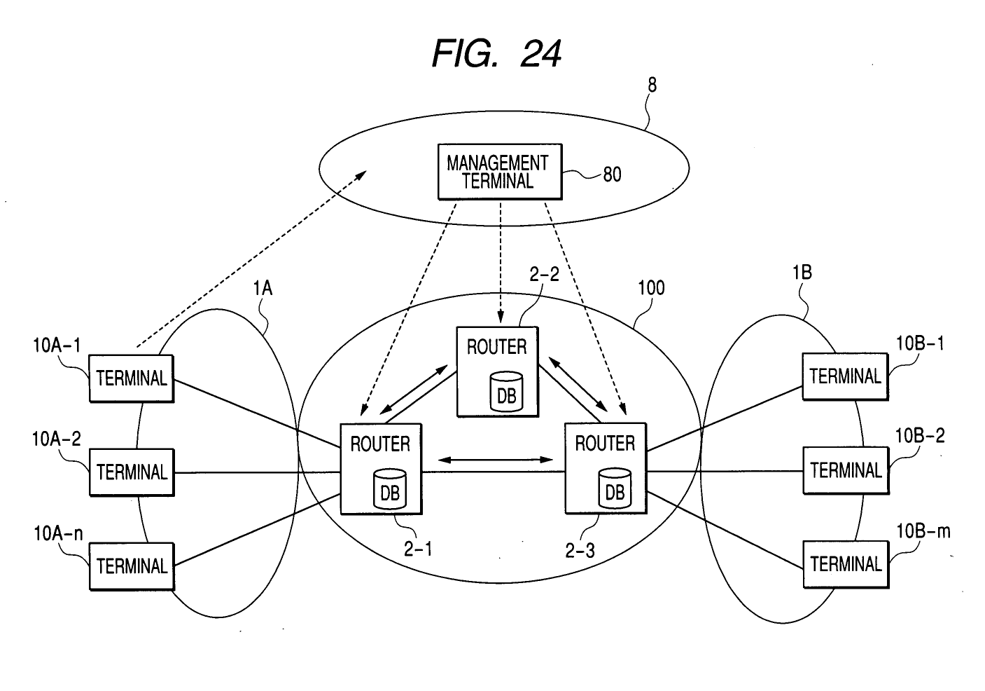

FIG. 23 shows a network configuration wherein each node apparatus of the communication network 100 is able to inform the network manager about information set in the data base, using a real-time bandwidth assurance function according to further embodiment of the present invention.

In FIG. 23, the control apparatus 40 and the communication apparatuses 20 (20-1 to 20-3) in the communication network 100 are connected to a management server 90 through a management network 9.

Upon receiving the control packet 60 from the terminal, the control apparatus 40 updates the data base 41, broadcasts the updated information to reflect in the data bases of other node apparatuses in the communication network 100. At this time, if the data bases of the control apparatus 40 and communication apparatuses 20 belong to the same control plane as the data base associated with the management server 90, the network manager can monitor one after another the updated data base contents on the display screen of the management server. The connection between the management server 90 and the communication network 100 may be restricted only between the management server 90 and the control apparatus 40. In this case, the data base of the management server 90 is updated in accordance with a broadcast message transmitted/received by the control apparatus 40.

According to the present invention, high quality communication services can occasionally be provided, in response to a user instruction for communication quality or communication form. In the configuration of the present invention, at least one control node apparatus (communication control apparatus) is installed in a communication network. With a protocol for communicating routing control information autonomously between data bases for storing packet transfer control information, new packet transfer control information is automatically set in other nodes apparatus in the communication network, upon updating of the packet transfer control information performed by the control node apparatus. Therefore, there is no need to configure a complicated network management system, and the operational cost of the communication network can thus be reduced.

1. A communication control apparatus to be located in a communication network including a plurality of node apparatuses, the communication control apparatus comprising:
a data base for storing packet transfer control information;
a received packet analyzing means for terminating a control packet when the control packet is received, the control packet including communication control information specified by a terminal user in its payload part;
means for updating said data base based on the communication control information specified in said control packet; and
data base information communication means for autonomously informing said plurality of node apparatuses in the communication network about contents of the updated data base.

2. The communication control apparatus according to claim 1, wherein
said data base information communication means communicates data base information in accordance with a predetermined communication protocol which is common to other data bases located at said plurality of node apparatuses to store packet transfer control information.

3. The communication control apparatus according to claim 1, wherein
said received packet analyzing means determines whether a received packet is a control packet, based on status of a particular header information element included in a header of the received packet.

4. The communication control apparatus according to claim 1, wherein
said data base further stores link status information and topology information of the communication network and a label conversion table information; and
said data base information communication means broadcasts the database information to other databases located at said plurality of node apparatuses in the communication network to store packet transfer control information, when the contents of the data base are updated by said updating means.

5. The communication control apparatus according to claim 1, further comprising
a packet transfer means for performing one of an optical cross-connect operation in layer 1 of an OSI reference model, a LAN switch operation in layer 2 of the reference model or an IP router operation in layer 3 of the reference model, with respect to user packets except the control packet.

6. A method of updating packet transfer control information in a packet communication network comprising a plurality of node apparatuses each having a data base for storing packet transfer control information, said packet communication network being connected to a plurality of access networks each connected to user terminals, the method comprising the steps of:
updating, when one of said node apparatuses receives a control packet including communication control information specified by a terminal user in its payload part, the data base associated with the node apparatus based on the communication control information specified in the received control packet; and
executing communication among said node apparatus which has updated said data base and the other node apparatuses in the communication network, in order to synchronize the packet transfer control information in the data bases of said plurality of node apparatuses.

7. The method of updating packet transfer control information according to claim 6, wherein:
said communication network logically comprises a data plane for transferring user packets transmitted from said user terminals through said plurality of node apparatuses, and a control plane for communicating the packet transfer control information among said plurality of data bases; and
one of said node apparatuses transfers a user packet to another one of said plurality of node apparatuses in said data plane upon receiving the user packet, and executes communication for synchronization of the packet transfer control information stored in the data base with the other data bases in said control plane upon updating the data base in response to the reception of the control packet.

8. A communication network comprising a plurality of node apparatuses and a plurality of access networks connected to user terminals, wherein each of said node apparatuses has a data base for storing packet transfer control information;
one of said node apparatuses has a data base information control means for updating the data base when the node apparatus receives a control packet including communication control information specified by a terminal, user in its payload part, based on the communication control information specified in a control packet; and
each of said node apparatuses has means for communicating data base information using a predetermined protocol in order to synchronize contents of said respective data bases.

9. The communication network according to claim 8, wherein:
said plurality of node apparatuses are logically coupled with each other through a data plane for transferring user packets and a control plane for communicating said data base information; and
a plurality of data bases in the control plane autonomously communicate the data base information using the predetermined protocol.

10. The communication network according to claim 8, wherein
an LSA (Link State Advertisement) protocol of OSPF-TE (Open Shortest Path First-Traffic Engineering) is used as the predetermined protocol.

11. The communication network according to claim 8, wherein
an LMP (Link Management Protocol) of OSPF-TE (Open Shortest Path First-Traffic Engineering) is used as the predetermined protocol.

12. The communication network according to claim 8, wherein
each of said plurality of node apparatuses sets a communication path to another node apparatus based on the stored information of the database, and transfers user packets through said communication path if the source of the user packets is a user terminal which has transmitted said control packet.
